(19) United States
(12) Patent Application Publication
(10) Pub. No.: US 2025/0056245 A1
(43) Pub. Date: Feb. 13, 2025

(54) WIRELESS COMMUNICATION METHOD, BEAM DIRECTION COLLECTION SYSTEM, TERMINAL DEVICE, AND NETWORK DEVICE

(71) Applicant: QUECTEL WIRELESS SOLUTIONS CO., LTD., Shanghai (CN)

(72) Inventors: Zheng ZHAO, Shanghai (CN); Ling LYU, Shanghai (CN); Zhongzhi YANG, Shanghai (CN)

(21) Appl. No.: 18/929,106

(22) Filed: Oct. 28, 2024

Related U.S. Application Data
(63) Continuation of application No. PCT/CN2022/091239, filed on May 6, 2022.

(51) Int. Cl. H04W 16/28; H04W 64/00

(52) U.S. Cl. CPC H04W 16/28; H04W 64/006

(57) ABSTRACT

A wireless communication method, a beam direction collection system, a terminal device, and a network device are provided. One example wireless communication method includes: transmitting, by a terminal device, beam information of the terminal device to a network device, wherein the network device comprises a location management function (LMF), and the beam information is transmitted by the terminal device to the LMF via a first base station; or the network device comprises a location calculation server, and the beam information is transmitted by the terminal device to the location calculation server by using a wireless network.

### CROSS-REFERENCE TO RELATED APPLICATIONS

The present application is a continuation of International Application No. PCT/CN2022/091239, filed on May 6, 2022, the disclosure of which is hereby incorporated by reference in its entirety.

### TECHNICAL FIELD

The present application relates to the field of communication technologies, and more specifically, to a wireless communication method, a beam direction collection system, a terminal device, and a network device.

### BACKGROUND

A communications system provided in a related technology locates a terminal device based on transmit beam information of a base station. In some scenarios, locating a terminal device based on transmit beam information of a base station may result in an inaccurate positioning result.

### SUMMARY

The present application provides a wireless communication method, a beam direction collection system, a terminal device, and a network device. Various aspects involved in the present application are described below.

According to a first aspect, a wireless communication method is provided. The method includes: transmitting, by a terminal device, beam information of the terminal device to a network device, where the network device includes a first base station, and the beam information is transmitted by the terminal device to the first base station, and transparently transmitted by the first base station to a location management function LMF; or the network device includes an LMF, and the beam information is transmitted by the terminal device to a first base station, and transparently transmitted by the first base station to the LMF; or the network device includes a location calculation server, and the beam information is transmitted by the terminal device to the location calculation server by using a wireless network.

According to a second aspect, a wireless communication method is provided. The method includes: receiving, by a network device, beam information of a terminal device transmitted by the terminal device, where the network device includes a first base station, and the beam information is transmitted by the terminal device to the first base station, and transparently transmitted by the first base station to a location management function LMF; or the network device includes an LMF, and the beam information is transmitted by the terminal device to a first base station, and transparently transmitted by the first base station to the LMF; or the network device includes a location calculation server, and the beam information is transmitted by the terminal device to the location calculation server by using a wireless network.

According to a third aspect, a terminal device is provided. The terminal device includes: a communications module, transmitting beam information of a terminal device to a network device, where the network device includes a first base station, and the beam information is transmitted by the terminal device to the first base station, and transparently transmitted by the first base station to a location management function LMF; or the network device includes an LMF, and the beam information is transmitted by the terminal device to a first base station, and transparently transmitted by the first base station to the LMF; or the network device includes a location calculation server, and the beam information is transmitted by the terminal device to the location calculation server by using a wireless network.

According to a fourth aspect, a network device is provided. The network device includes: a communications module, receiving beam information of a terminal device transmitted by the terminal device, where the network device includes a first base station, and the beam information is transmitted by the terminal device to the first base station, and transparently transmitted by the first base station to a location management function LMF; or the network device includes an LMF, and the beam information is transmitted by the terminal device to a first base station, and transparently transmitted by the first base station to the LMF; or the network device includes a location calculation server, and the beam information is transmitted by the terminal device to the location calculation server by using a wireless network.

According to a fifth aspect, a beam direction collection system is provided. The beam direction collection system is located outside a baseband chip, used for wireless communication, of a terminal device, and the beam direction collection system includes: a beam sweeping portion, controlling an antenna system of the terminal device to perform beam sweeping to obtain the beam information; and a communication portion, communicating with a location calculation server to transmit the beam information to the location calculation server; or communicating with the baseband chip to transmit the beam information to a base station by using the baseband chip.

According to a sixth aspect, a terminal device is provided. The terminal device includes an antenna system; a baseband chip used for wireless communication; and the beam direction collection system according to the fifth aspect.

According to a seventh aspect, a terminal device is provided. The terminal device includes a memory and a processor, where the memory is configured to store a program, and the processor is configured to invoke the program in the memory to cause the terminal device to execute the method according to the first aspect.

According to an eighth aspect, a network device is provided. The device includes a memory and a processor, where the memory is configured to store a program, and the processor is configured to invoke the program in the memory to cause the network device to execute the method according to the second aspect.

According to a ninth aspect, an apparatus is provided. The apparatus includes a processor, invoking a program from a memory to cause the apparatus to execute the method according to the first aspect.

According to a tenth aspect, an apparatus is provided. The apparatus includes a processor, invoking a program from a memory to cause the apparatus to execute the method according to the second aspect.

According to an eleventh aspect, a chip is provided. The chip includes a processor, invoking a program from a memory to cause a device on which the chip is installed to execute the method according to the first aspect.

According to a twelfth aspect, a chip is provided. The chip includes a processor, invoking a program from a memory to cause a device on which the chip is installed to execute the method according to the second aspect.

According to a thirteenth aspect, a computer-readable storage medium is provided. The computer-readable storage medium stores a program that causes a computer to execute the method according to the first aspect.

According to a fourteenth aspect, a computer-readable storage medium is provided. The computer-readable storage medium stores a program that causes a computer to execute the method according to the second aspect.

According to a fifteenth aspect, a computer program product is provided. The computer program product includes a program, where the program causes a computer to execute the method according to the first aspect.

According to a sixteenth aspect, a computer program product is provided. The computer program product includes a program, where the program causes a computer to execute the method according to the first aspect.

According to a seventeenth aspect, a computer program is provided, where the computer program causes a computer to execute the method according to the first aspect.

According to an eighteenth aspect, a computer program is provided, where the computer program causes a computer to execute the method according to the second aspect.

In embodiments of the present application, the terminal device transmits beam information of the terminal device to the network device, thereby being beneficial to improve positioning accuracy of the terminal device.

### BRIEF DESCRIPTION OF THE DRAWINGS

FIG. 1 is a diagram of a system architecture of a communications system to which an embodiment of the present application is applicable.

FIG. 2 is a diagram of a system architecture of a positioning system to which an embodiment of the present application is applicable.

FIG. 3 is an example diagram of a beamforming procedure.

FIG. 4 is an example diagram of lines of sight between a terminal device and base stations.

FIG. 5 is a schematic flowchart of a wireless communication method according to an embodiment of the present application.

FIG. 6 is a schematic structural diagram of a terminal device according to an embodiment of the present application.

FIG. 7 is an example diagram of a more specific structure of the terminal device shown in FIG. 6.

FIG. 8 is a flowchart of collecting beam information by using the terminal device shown in FIG. 6.

FIG. 9 is a schematic structural diagram of a terminal device according to another embodiment of the present application.

FIG. 10 is a flowchart of collecting beam information by using the terminal device shown in FIG. 9.

FIG. 11 is an example diagram of a line of sight detection process according to an embodiment of the present application.

FIG. 12 is an example diagram of a line of sight detection process according to another embodiment of the present application.

FIG. 13 is a schematic structural diagram of a terminal device according to another embodiment of the present application.

FIG. 14 is a schematic structural diagram of a network device according to an embodiment of the present application.

FIG. 15 is a schematic structural diagram of an apparatus according to an embodiment of the present application.

### DETAILED DESCRIPTION OF THE EMBODIMENTS

### Communications System

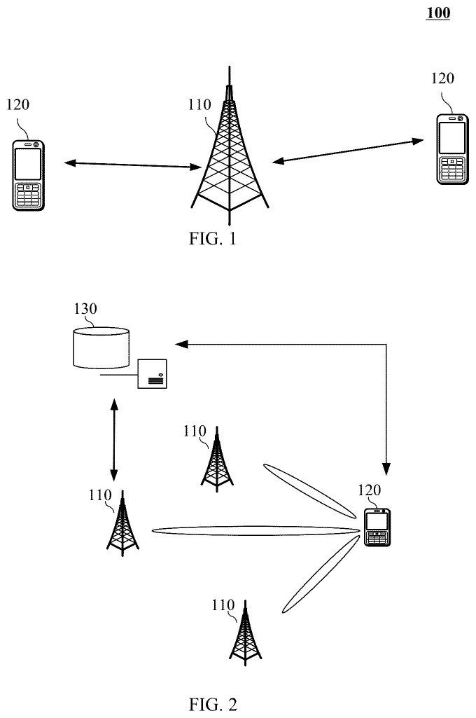

FIG. 1 shows a wireless communications system 100 to which an embodiment of the present application is applicable. The wireless communications system 100 may include a base station 110 and terminal devices 120. The base station 110 may be a device in communication with the terminal devices 120. The base station 110 may provide communication coverage for a specific geographic area, and may communicate with the terminal device 120 located within the coverage.

FIG. 1 exemplarily shows one base station and two terminals. Optionally, the wireless communications system 100 may include a plurality of base stations, and another quantity of terminal devices may be included in coverage of each base station. This is not limited in embodiments of the present application.

Optionally, the wireless communications system 100 may further include another network entity such as a network controller or a mobility management entity, which is not limited in embodiments of the present application.

It should be understood that the technical solutions of embodiments of the present application may be applied to various communications systems, such as a 5th generation (5th generation, 5G) system or new radio (new radio, NR), a long-term evolution (long term evolution, LTE) system, an LTE frequency division duplex (frequency division duplex, FDD) system, and LTE time division duplex (time division duplex, TDD). The technical solutions provided in the present application may further be applied to a future communications system, such as a 6th generation mobile communications system or a satellite communications system.

The terminal device in embodiments of the present application may also be referred to as a user equipment (user equipment, UE), an access terminal, a subscriber unit, a subscriber station, a mobile site, a mobile station (mobile station, MS), a mobile terminal (mobile Terminal, MT), a remote station, a remote terminal, a mobile device, a user terminal, a terminal, a wireless communications device, a user agent, a user apparatus, or the like. The terminal device in embodiments of the present application may be a device providing a user with voice and/or data connectivity and capable of connecting people, objects, and machines, such as a handheld device or vehicle-mounted device having a wireless connection function. The terminal device in embodiments of the present application may be a mobile phone (mobile phone), a tablet computer (Pad), a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in smart city (smart city), a wireless terminal in smart home (smart home), or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relay of a communication signal through a base station.

The base station in the embodiments of the present application may be a device for communicating with the terminal device. The base station may also be referred to as an access network device or a wireless access network device. The base station in the embodiments of the present application may be a radio access network (radio access network, RAN) node (or device) that connects the terminal device to a wireless network. The base station may broadly cover various names below, or may be replaced with the following names, such as a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master MeNB, a secondary SeNB, a multi-standard radio (MSR) node, a home base station, a network controller, an access node, a wireless node, an access point (access point, AP), a transmission node, a transceiver node, a baseband unit (base band unit, BBU), a remote radio unit (Remote Radio Unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communication, a network-side device in a 6G network, a device that functions as a base station in a future communications system, or the like. The base station may support networks of a same access technology or different access technologies. A specific technology and a specific device form used by the base station are not limited in embodiments of the present application.

The base station may be stationary, or may be mobile. For example, a helicopter or an unmanned aerial vehicle may be configured to function as a mobile base station, and one or more cells may move depending on a location of the mobile base station. In other examples, a helicopter or an unmanned aerial vehicle may be configured to function as a device in communication with another base station.

In some deployments, the base station in embodiments of the present application may be a CU or a DU, or the base station includes a CU and a DU. The gNB may further include an AAU.

The base station and the terminal device may be deployed on land, including being indoors or outdoors, handheld, or vehicle-mounted, may be deployed on a water surface, or may be deployed on a plane, a balloon, or a satellite in the air. In embodiments of the present application, a scenario in which the base station and the terminal device are located is not limited.

### Positioning Technology in the Communications System

As shown in FIG. 2, a communications system 100 may further include a positioning device 130. The positioning device 130 may be configured to determine location information of a terminal device. The positioning device 130 may be located in a core network. The positioning device 130 may sometimes also be referred to as a positioning server. An NR system is used as an example, and the positioning device 130 may be a location management function (location management function, LMF). Another communications system is used as an example, and the positioning device 130 may be a location management unit (location management unit, LMU), a location management center (location management center, LMC), or an evolved serving mobile location center (evolved serving mobile location center, E-SMLC). It may be understood that, the positioning device 130 may alternatively be another network element, node, or device for determining the location information of the terminal device, for example, may be a network element or node in a future communications system for determining the location information of the terminal device. A name of the positioning device is not specifically limited in embodiments of the present application.

Positioning in the communications system 100 includes uplink positioning and downlink positioning. In some communications systems (for example, the NR system), downlink positioning is performed based on a positioning reference signal (positioning reference signal, PRS). The PRS, also referred to as a downlink positioning reference signal (downlink positioning reference signal, DL-PRS), is a reference signal for a positioning. For example, in a downlink positioning process, the terminal device 120 may first measure a PRS transmitted by a serving cell and a neighboring cell (or a neighbor cell), and estimate related information of positioning measurement. The terminal device 120 may then report the related information of positioning measurement to the positioning device 130 as a measurement result of the PRS. The positioning device 130 may calculate a location of the terminal device 120 based on the related information that is of the positioning measurement and that is reported by the terminal device 120, to obtain the location information of the terminal device 120.

In some communications systems (for example, the NR system), uplink positioning is performed based on an SRS. For example, in an uplink positioning process, the terminal device 120 transmits an SRS. The base station 110 (a base station of a serving cell and a base station of a neighboring cell) may obtain a measurement result based on the SRS transmitted by the terminal. The measurement result of the SRS may include related information of positioning measurement. The base station 110 may then transmit the related information of the positioning measurement to the positioning device 130. The positioning device 130 may calculate a location of the terminal device 120 based on the related information that is of the positioning measurement and that is reported by the base station 110, to obtain the location information of the terminal device 120.

The related information of the positioning measurement may include one or more of following information: time information, distance information, power information, or angle information. More specifically, the related information of positioning measurement may include one or more of the following information: a time difference of arrival (time difference of arrival, TDOA), an angle difference of arrival (angle difference of arrival, ADOA), a reference signal received power (reference signal receive power, RSRP), or the like.

### Beamforming System

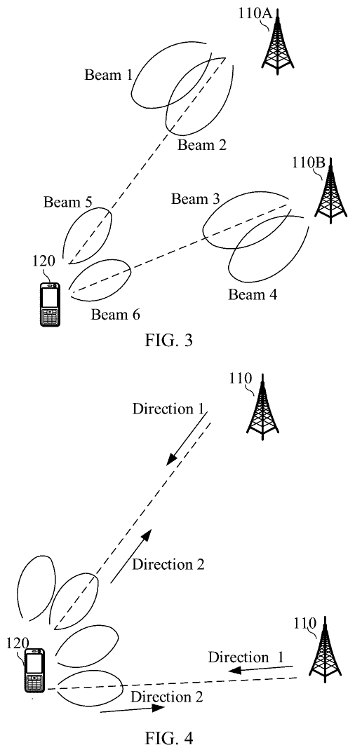

In some communications systems (such as an NR system), a terminal device is provided with a beamforming system, thereby achieving a beamforming function. During downlink reception, the beamforming system may be configured to receive a downlink signal. For example, in a downlink reception process, the terminal device performs sweeping on receive beams by using the beamforming system, and receives beams in different directions (or different orientations). Then, the terminal device may select an optimal beam for downlink signal reception from the receive beams based on signal strengths of all receive beams. FIG. 3 is used as an example. A terminal device 120 receives downlink beams (for example, a beam 1 and a beam 2 in FIG. 3) from a base station 110A, and receives downlink beams (for example, a beam 3 and a beam 4 in FIG. 3) from a base station 110B. After comparing signals on the beams by using the beamforming system, the terminal device 120 finally selects a beam 5 to receive downlink signals from the base station 110A and selects a beam 6 to receive downlink signals from the base station 110B.

### Assumption of a Line of Sight Between a Base Station and a Terminal Device

In all communications systems provided in a related technology, it is assumed that there is a line of sight (or referred to as a direct path) between a base station and a terminal device. After obtaining transmit beam information of the base station, the positioning device may accordingly obtain a direction of a receive beam of the terminal device based on the assumption of a line of sight. FIG. 4 is used as an example. A direction of a transmit beam of a base station 110 is a direction 1; and based on the assumption of a line of sight, a direction of a receive beam of a terminal device 120 is a direction 2.

In some scenarios (for example, a complex urban environment), there is no line of sight between a base station and a terminal device, or a line of sight between a base station and a terminal device is not a signal transmission path with a maximum power. Therefore, the direction of the receive beam of the terminal device that is determined by the positioning device based on the assumption of a line of sight may not match an actual situation, resulting in reducing of positioning accuracy of the communications system.

In addition, as mentioned above, in a positioning process, the positioning device acquires the transmit beam information of the base station from the base station. However, in some cases, the positioning device may not be able to acquire this information. For example, if the positioning device is not a device provided by an operator, the positioning device may not be able to obtain the transmit beam information from the base station. If the positioning device cannot obtain the transmit beam information of the base station, a positioning failure may be caused or positioning accuracy may be affected.

To resolve one or more of the foregoing problems, the embodiments of the present application are described in detail below.

FIG. 5 is a schematic flowchart of a wireless communication method according to an embodiment of the present application. The method shown in FIG. 5 may be executed by a terminal device and a network device.

As shown in FIG. 5, in Step S510, transmitting beam information of a terminal device to the network device by the terminal device.

In some embodiments, the network device may include a first base station. The first base station may be any base station that provides an access service for the terminal device. In an example, the first base station may be a gNB. Further, in some embodiments, after receiving the beam information of the terminal device, the first base station may transmit the beam information to the positioning device (for example, the first base station may transparently transmit the beam information of the terminal device to the positioning device). The positioning device may be located in a core network. For example, in an NR system, the positioning device may be an LMF. For example, in another communications system, the positioning device may be an LMU, an LMC, or an E-SMLC.

In some embodiments, the network device may include a positioning device. The positioning device may be located in a core network. For example, in an NR system, the positioning device may be an LMF. For example, in another communications system, the positioning device may be an LMU, an LMC, or an E-SMLC. It may be understood that, the positioning device may alternatively be another network element, node, or device for determining the location information of the terminal device, for example, may be a network element or node in a future communications system for determining the location information of the terminal device, or may be an independently deployed positioning device for location calculations. A name of the positioning device is not specifically limited in embodiments of the present application. For example, the positioning device may also be referred to as a positioning server or a location calculation server.

The beam information of the terminal device may be understood as beam information used by the terminal device. For example, the beam information may indicate a beam which is used by the terminal device to receive a signal from the base station. For another example, the beam information may indicate a beam which is used by the terminal device to transmit a signal to the base station. The beam information may include one or more of following: an absolute direction of a beam, a relative direction of a beam, or a sequence number of a beam. An absolute direction of a beam may indicate an angle by which the beam moves relative to a reference absolute direction. The reference absolute direction may include, for example, one or more of following directions: true north, true south, true west, true east, an angle offset relative to true north, an angle offset relative to true south, an angle offset relative to true west, or an angle offset relative to true east. The reference absolute direction may be, for example, predefined in a protocol, or may be notified by the network device to the terminal device by using signalling. A relative direction of a beam may refer to an offset direction of the beam relative to a reference direction. The reference direction may be, for example, a direction of a beam, or may be a direction relative to a connection line between a network device and the terminal device. The reference direction may be predefined in a protocol, or may be notified by the network device to the terminal device by using signalling. A sequence number of a beam may have an association relationship with an absolute direction of the beam (or a relative direction of the beam). The association relationship may be predefined in a protocol, or may be notified by the network device to the terminal device by using signalling. The beam information of the terminal device may include beam information for one base station, or may include beam information for a plurality of base stations. If the beam information of the terminal device includes the beam information, for the plurality of base stations, of the terminal device, the beam information of the terminal device may further indicate a correspondence between the plurality of base stations and the beam information.

The terminal device may directly transmit the beam information of the terminal device to the network device, or may indirectly transmit the beam information to the network device. For example, the network device is a base station. The terminal device may directly transmit the beam information of the terminal device to the network device by using an air interface. For another example, the network device is a positioning device in a core network. The terminal device may directly transmit the beam information of the terminal device to the positioning device by using a communications interface between the terminal device and the positioning device, or may indirectly report the beam information of the terminal device to the network device by using a base station.

In some embodiments, the beam information of the terminal device may include receive beam information of the terminal device. The receive beam information of the terminal device may include one or more of a signal strength, a direction (or referred to as an orientation), or a width of a receive beam of the terminal device.

In some embodiments, the direction of the receive beam of the terminal device may include an absolute direction of the receive beam. The absolute direction of the receive beam of the terminal device may be obtained by using a direction sensor. The direction sensor may be, for example, a compass. In an example, the terminal device may determine the direction of the receive beam (the direction may be a direction of the receive beam relative to the terminal device, that is, a direction based on the terminal device that functions as a coordinate system) based on a location of an antenna, and determine a true north direction by using the direction sensor. Then, the terminal device may determine the absolute direction of the receive beam based on a direction difference between the true north direction and a direction of the receive beam. The terminal device may carry, in addition to the absolute direction of the receive beam of the terminal device, an identity (identity, ID) of a base station corresponding to the receive beam, in the receive beam information to be transmitted to the network device.

In some embodiments, the direction of the receive beam of the terminal device may include a relative direction of the receive beam. The relative direction of the receive beam may indicate a difference between directions of receive beams, for a plurality of base stations, of the terminal device. For example, the terminal device may use a base station as a reference base station (that is, the base station functions as a reference for measuring the relative direction). When determining the relative direction of the receive beam, the terminal device may determine a difference of a direction of a receive beam of a non-reference base station relative to a direction of a receive beam of the reference base station. The direction difference may function as the relative direction of the receive beam of the terminal device that is mentioned above. The terminal device may carry, in addition to the relative direction of the receive beam of the terminal device, IDs of the reference base station and the non-reference base station, in the receive beam information to be transmitted to the network device.

In some embodiments, the signal strength of the receive beam of the terminal device may include one or more of following information: a reference signal received power (reference signal receiving power, RSRP), reference signal received quality (reference signal receiving quality, RSRQ), a received signal strength indicator (received signal strength indicator, RSSI), a received signal level (received signal level, Rxlev), or other information.

In some embodiments, the signal strength of the receive beam of the terminal device may include an absolute signal strength of the receive beam, or may include a relative signal strength of the receive beam. The relative signal strength of the receive beam may indicate a difference between signal strengths of receive beams, for a plurality of base stations, of the terminal device. For example, the terminal device may use a base station as a reference base station (that is, the base station functions as a reference for measuring the relative direction). When determining the direction of the receive beam, the terminal device may determine a signal strength difference of a signal strength of the receive beam of a non-reference base station relative to a signal strength of the receive beam of the reference base station. The signal strength difference may function as the relative signal strength of the receive beam of the terminal device that is mentioned above. The terminal device may carry, in addition to the relative signal strength of the receive beam of the terminal device, IDs of the reference base station and the non-reference base station, in the receive beam information to be transmitted to the network device.

In some embodiments, the beam information of the terminal device may include transmit beam information of the terminal device. The transmit beam information of the terminal device may include one or more of a signal strength, a direction (or referred to as an orientation), or a width of a transmit beam of the terminal device.

In some embodiments, the direction of the transmit beam of the terminal device may include an absolute direction of the transmit beam. The absolute direction of the transmit beam of the terminal device may be obtained by using a direction sensor. The direction sensor may be, for example, a compass. In an example, the terminal device may determine the direction of the transmit beam (the direction may be a direction of the transmit beam relative to the terminal device, that is, a direction based on the terminal device that functions as a coordinate system) based on a location of an antenna, and determine a true north direction by using the direction sensor. Then, the terminal device may determine the absolute direction of the transmit beam based on a direction difference between the true north direction and a direction of the transmit beam. The terminal device may carry, in addition to the absolute direction of the transmit beam of the terminal device, an ID of a base station corresponding to the transmit beam, in the transmit bema information to be transmitted to the network device.

In some embodiments, the direction of the transmit beam of the terminal device may include a relative direction of the transmit beam. The relative direction of the receive beam may indicate a difference between directions of transmit beams, for a plurality of base stations, of the terminal device. For example, the terminal device may use a base station as a reference base station (that is, the base station functions as a reference for measuring the relative direction). When determining the direction of the transmit beam, the terminal device may determine a direction difference of a direction of the transmit beam of a non-reference base station relative to a direction of the transmit beam of the reference base station. The direction difference may function as the relative direction of the transmit beam of the terminal device that is mentioned above. The terminal device may carry, in addition to the relative direction of the transmit beam of the terminal device, IDs of the reference base station and the non-reference base station, in the transmit beam information to be transmitted to the network device.

In some embodiments, the signal strength of the transmit beam of the terminal device may include one or more of following information: an RSRP, RSRQ, an RSSI, an Rxlev, or other information.

In some embodiments, the signal strength of the transmit beam of the terminal device may include an absolute signal strength of the transmit beam, or may include a relative signal strength of the transmit beam. The relative signal strength of the transmit beam may indicate a difference between signal strengths of transmit beams, for a plurality of base stations, of the terminal device. For example, the terminal device may use a base station as a reference base station (that is, the base station functions as a reference for measuring the relative direction). When determining the direction of the transmit beam, the terminal device may determine a signal strength difference of a signal strength of the transmit beam of a non-reference base station relative to a signal strength of the transmit beam of the reference base station. The signal strength difference may function as the relative signal strength of the transmit beam of the terminal device that is mentioned above. The terminal device may carry, in addition to the relative signal strength of the transmit beam of the terminal device, IDs of the reference base station and the non-reference base station, in the transmit beam information to be transmitted to the network device.

In some embodiments, the beam information of the terminal device may be positioning information, or may be information used for locating the terminal device. For example, the beam information of the terminal device may be used to locate the terminal device. For another example, the beam information of the terminal device may be used to determine whether there is a line of sight between the terminal device and a base station (for example, may be the first base station mentioned above, or may certainly be another base station). A detection result of the line of sight may be used to locate the terminal device. Certainly, in other embodiments, the detection result of the line of sight may also be used for other operations than positioning.

In some embodiments, whether there is a line of sight between the terminal device and a base station is determined based on a first condition. The first condition is associated with one or more of following information: a direction of a receive beam of the terminal device; a direction of a transmit beam of the base station; a width of a receive beam of the terminal device; or a width of a transmit beam of the base station.

In some embodiments, the first condition is associated with one or more of following information: a difference between a direction of a receive beam of the terminal device and a direction of a transmit beam of the base station; or a sum of a width of a receive beam of the terminal device and a width of a transmit beam of the base station.

In some embodiments, the first condition includes: 180−(Δθ+Δα)/2<=|α−θ|<=180+(Δθ+Δα)/2, where α represents a direction of a receive beam of the terminal device, θ represents a direction of a transmit beam of the base station, Δα represents a width of the receive beam of the terminal device, and Δθ represents a width of the transmit beam of the base station.

In some embodiments, the first condition is associated with one or more of following information: a difference between directions of receive beams of the terminal device relative to a plurality of reference base stations (the plurality of reference base stations may include the first base station mentioned above, or may not include the first base station mentioned above); a difference between directions of transmit beams of a plurality of reference base stations; or a sum of widths of receive beams of the terminal device relative to a plurality of reference base stations.

In some embodiments, the first condition includes: |θ1−θ2|<=|α1−α2|+(Δθ1+Δθ2+Δα2+Δα1)/2, where θ1 represents a direction of a transmit beam of a first reference base station in the plurality of reference base stations, α1 represents a direction of a receive beam of the terminal device relative to the first reference base station, Δθ1 represents a width of the transmit beam of the first reference base station, θ2 represents a direction of a transmit beam of a second reference base station in the plurality of reference base stations, α2 represents a direction of a receive beam of the terminal device relative to the second reference base station, Δθ1 represents a width of the transmit beam of the second reference base station, Δα1 represents a width of the receive beam of the terminal device relative to the first reference base station, and Δα2 represents a width of the receive beam of the terminal device relative to the second reference base station.

In some embodiments, in a case that the positioning device cannot obtain beam information of a transmit beam or a receive beam of a base station (or neither the positioning device nor the terminal device can obtain the beam information of the transmit beam or the receive beam of the base station), the terminal device may transmit the beam information of the terminal device to the positioning device. The positioning device may locate the terminal device based on the beam information of the receive beam of the terminal device. For example, if the positioning device is not a device belonging to an operator, the positioning device may not be able to obtain beam information of a transmit beam of the base station. In this case, the terminal device may report the beam information of the terminal device to the positioning device based on a communication link between the terminal device and the positioning device, so that the positioning device locates the terminal device based on the beam information of the terminal device.

Before Step S510, the method illustrated in FIG. 5 may further include Step S505, that is, acquiring the beam information of the terminal device by the terminal device.

In some embodiments, the terminal device may acquire the beam information of the terminal device based on beam sweeping.

In some embodiments, the terminal device may include an antenna system and a beam direction collection system (or referred to as a MIMO system) connected to the antenna system. The terminal device may acquire the beam information of the terminal device by using the beam direction collection system. For example, the terminal device may perform beam sweeping (beam sweeping may be performed by controlling an antenna direction of the antenna system) by using the beam direction collection system (or a beam sweeping portion in the beam direction collection system), so as to acquire the beam information by using the beam direction collection system. In addition, the beam direction collection system may further include a communication portion. The communication portion may be configured to realize a function of communication between the beam direction collection system and the outside. For example, the communication portion may be configured to perform wireless communication with an external location calculation server. Alternatively, the communication portion may be configured to communicate with a baseband chip of the terminal device, so as to transmit the beam information of the terminal device to the base station by using the baseband chip, or the baseband chip performs processing such as positioning and determining of a direct path by using the beam information of the terminal device. The base station may transparently transmit the beam information to the LMF. The communication portion may be, for example, a communications interface that can communicate with the baseband chip, or may be a wireless communications component that can independently perform wireless communication.

In an example, the beam direction collection system (or a beam sweeping portion in the beam direction collection system) may include an antenna direction control system and an antenna direction adjustment system. The antenna direction control system may determine an antenna direction adjustment value for the antenna system based on a measurement result of a received signal of the antenna system. The antenna direction adjustment system may adjust an antenna direction of the antenna system based on the antenna direction adjustment value during a process of the beam sweeping. The antenna direction adjustment system may be implemented in multiple manners. For example, a reflector is disposed in each antenna in the antenna system of the terminal device. Adding the reflector may improve sensitivity of receiving an antenna signal, and may also block and shield against radio waves from a back side direction of the reflector, thereby reducing interference to the antenna. The adjustment of the antenna direction may be implemented by adjusting an angle of the reflector. A change in an angle of the reflector may cause the terminal device to receive or transmit signals in different directions, thereby implementing signal directional reception or transmission of the terminal device. Continuously adjusting a direction of a receive antenna of the terminal device may implement receive beam sweeping. The angle of the reflector may be changed in multiple manners. For example, the antenna system may be disposed in a rotating table, and may be rotated by an angle at a regular interval. An angle by which the rotating table is rotated between two measurements is recorded, so that angle information of the receive antenna between the two measurements may be obtained, thereby implementing beam sweeping and measurement. For another example, the antenna direction adjustment system may alternatively adjust the antenna direction by using a phase modulation system (such as a phase shifter) that uses an antenna array.

In some embodiments, the beam direction collection system may transmit the beam information to the baseband chip, and transmit the beam information to the network device by using the baseband chip.

In some embodiments, the terminal device may acquire the beam information of the terminal device by using a device outside the baseband chip. For example, for the terminal device, the beam direction collection system may be arranged outside the baseband chip. Then, the terminal device may perform beam sweeping by using the beam direction collection system, so as to obtain the beam information of the terminal device. The beam direction collection system is arranged outside the baseband chip, and is not controlled by the baseband chip, such that the terminal device may obtain direction information of the beam, even if the baseband chip does not provide or does not support an interface in a direction of a receive beam. The beam direction collection system may communicate with the baseband chip by using the communication portion disposed inside the beam direction collection system, so as to transmit the collected beam information to the LMF. Alternatively, the beam direction collection system may directly transmit the beam information to the location calculation server over a wireless network by using the communication portion disposed inside the beam direction collection system. Alternatively, the beam direction collection system may communicate with the baseband chip by using the communication portion disposed inside the beam direction collection system, so as to transmit the collected beam information to the location calculation server.

In a process of performing beam sweeping on a receive beam of the terminal device, the terminal device needs to measure a received signal of the antenna system. The measurement of the received signal may refer to measuring power information and/or interference information of the received signal. For example, the terminal device may measure one or more of following indicators of a received signal: an RSSI, an RSRP, RSRQ, or a signal to interference plus noise ratio (signal to interference plus noise ratio, SINR). In some embodiments, the measurement result may further include direction information of the terminal device, for example, an absolute direction of the terminal device or a direction difference of the terminal device relative to a direction (for example, a true north direction). The terminal device may measure a received signal in a plurality of manners. For example, the terminal device may measure a received signal of the antenna system by using the baseband chip. For another example, the terminal device may measure a received signal of the antenna system by using the beam direction collection system arranged outside the baseband chip mentioned above.

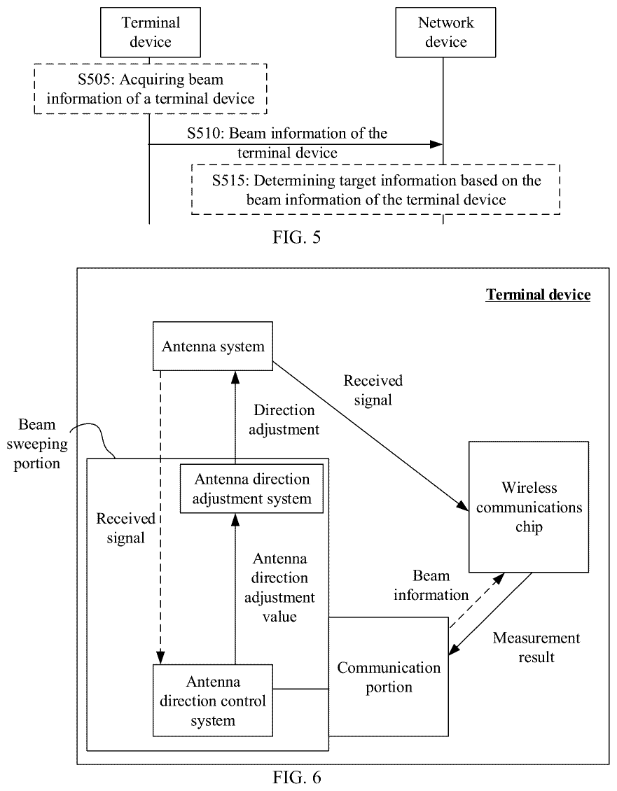

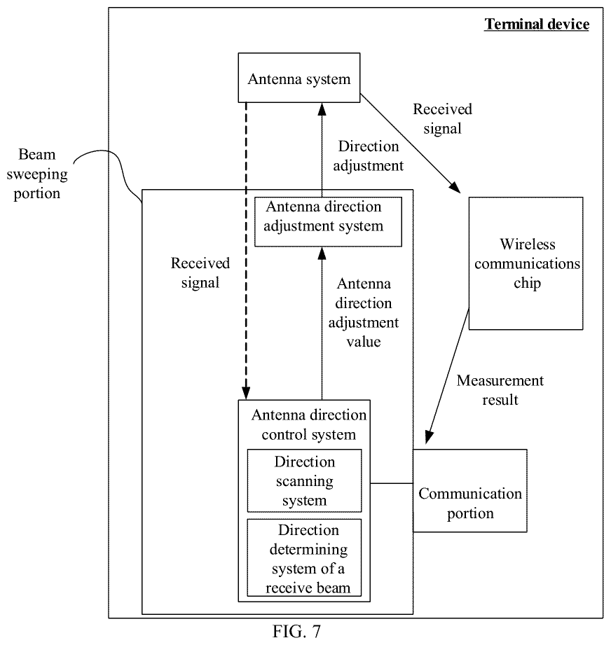

With reference to FIG. 6 to FIG. 8, a possible manner of acquiring beam information of a terminal device is provided below. FIG. 6 shows a possible structure of the terminal device. Referring to FIG. 6, the terminal device may include a baseband chip, a beam direction collection system, and an antenna system. The beam direction collection system is located outside the baseband chip. The beam direction collection system includes an antenna direction control system and an antenna direction adjustment system. FIG. 7 further shows an example of an internal structure of the antenna direction control system. Referring to FIG. 7, the antenna direction control system may further include a direction scanning system and a direction (which may also be referred to as a user direction) determining system of a receive beam.

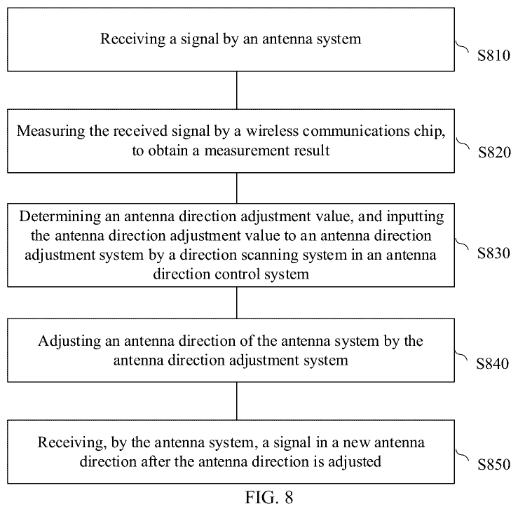

FIG. 8 is a flowchart of collecting beam information based on the terminal device shown in FIG. 6. FIG. 8 includes Step S810 to Step S850, and steps in FIG. 8 are described in detail below.

In Step S810, receiving a signal by the antenna system.

In Step S820, measuring the received signal by the baseband chip to obtain a measurement result. The measurement result may be, for example, measured power information. The baseband chip may transmit the measurement result to the antenna direction control system, so that the antenna direction control system records the measurement result and an antenna direction (or an antenna angle) corresponding to the measurement result.

In Step S830, determining an antenna direction adjustment value, and inputting the antenna direction adjustment value to the antenna direction adjustment system, by the direction scanning system (as shown in FIG. 7) in the antenna direction control system.

In Step S840, adjusting an antenna direction of the antenna system by the antenna direction adjustment system.

For example, the antenna direction adjustment system may control a rotary table in a direction of the reflector, so as to adjust the antenna direction of the antenna system. Alternatively, the antenna direction adjustment system may adjust the phase modulation system of the antenna array, so as to adjust the antenna direction of the antenna system.

In Step S850, after the antenna direction is adjusted, receiving a signal in a new antenna direction by the antenna system. Step S810 to Step S850 are repeated until the antenna system completes beam sweeping in all directions. Next, the direction determining system (as shown in FIG. 7) of the receive beam may determine an optimal receive direction based on magnitude of power of received signals of the antenna system in various directions, and use the optimal receive direction as a direction of the receive beam. Then, the antenna direction control system may transmit the beam information including the direction of the receive beam to the positioning device, or feed back the beam information to the baseband chip, and feed back the beam information to the base station or the positioning device by using the baseband chip system.

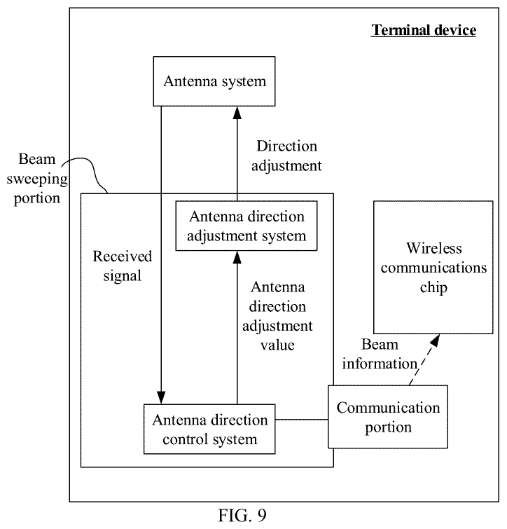

With reference to FIG. 9 and FIG. 10, another possible manner of acquiring beam information of a terminal device is provided below. FIG. 9 shows another example of a structure of the terminal device. The terminal structure shown in FIG. 9 is generally similar to the structure shown in FIG. 6. FIG. 9 mainly differs from FIG. 6 in that the antenna direction control system is directly connected to the antenna system to measure the receive beam, rather than measuring the receive beam by using the baseband chip.

FIG. 10 is a flowchart of collecting beam information based on the terminal device shown in FIG. 9. FIG. 10 includes Step S1010 to Step S1050, and steps in FIG. 10 are described in detail below.

In Step S1010, receiving a signal by the antenna system.

In Step S1020, measuring a received signal by the antenna direction control system to obtain a measurement result.

In Step S1030, determining an antenna direction adjustment value, and inputting the antenna direction adjustment value to the antenna direction adjustment system, by the direction scanning system in the antenna direction control system.

In Step S1040, adjusting an antenna direction of the antenna system by the antenna direction adjustment system.

For example, the antenna direction adjustment system may control a rotary table in a direction of the reflector, so as to adjust the antenna direction of the antenna system. Alternatively, the antenna direction adjustment system may adjust the phase modulation system of the antenna array, so as to adjust the antenna direction of the antenna system.

In Step S1050, after the antenna direction is adjusted, the antenna system receives a signal in a new antenna direction. Step S1010 to Step S1050 are repeated until the antenna system completes beam sweeping in all directions. Next, the direction determining system (as shown in FIG. 7) of the receive beam may determine an optimal receive direction based on magnitude of power of received signals of the antenna system in various directions, and use the optimal receive direction as a direction of the receive beam. Then, the antenna direction control system may transmit the beam information including the direction of the receive beam to the positioning device, or feed back the beam information to the baseband chip, and feed back the beam information to the base station or the positioning device by using the baseband chip system.

To simplify the design, in the embodiment illustrated in FIG. 10, the direction of the receive beam may be acquired by using a phase shifter and a combiner. For example, signals of various antennas in the antenna system may be phase-shifted by different phases, then phase-shifted signals of the various antennas are combined, and the direction of the receive beam is determined based on power of the signals.

The process of collecting and transmitting the beam information of the terminal device is described in detail above with reference to FIG. 5 to FIG. 10. After receiving the beam information of the terminal device, the network device may process the beam information. A manner in which the network device processes the beam information is described in detail below with specific embodiments.

Referring to FIG. 5 again, in some embodiments, the method in FIG. 5 may further include Step S515, that is, determining target information based on the beam information of the terminal device by the network device.

The target information may indicate whether there is a line of sight between the terminal device and the base station. In other words, the network device may determine, based on the beam information of the terminal device, whether there is a line of sight between the terminal device and a base station (which may be any base station that transmits a beam to the terminal device).

In some embodiments, the network device may determine, based on the beam information of the terminal device and beam information of a base station, whether there is a line of sight between the terminal device and the base station. That the network device is a positioning device in a core network is used as an example. The beam information of the base station may be obtained from the base station, that is, the base station reports the beam information to the positioning device.

For example, the network device may determine, based on the beam information of the terminal device and the beam information of the base station, a difference between directions of the receive beam of the terminal device and the transmit beam of the base station. If the direction difference is less than a threshold, it may be determined that there is a line of sight between the terminal device and the base station.

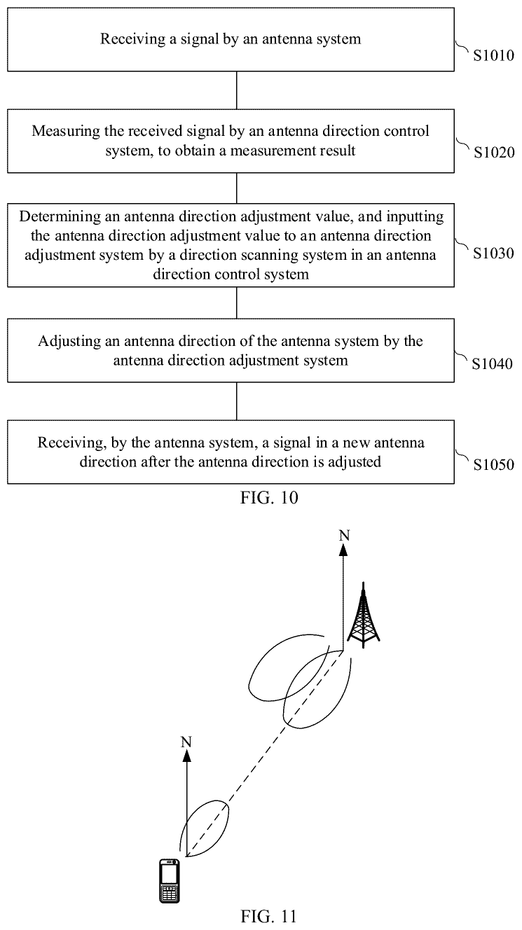

With reference to FIG. 11, an example of a process of detecting a line of sight is provided below by using an example in which the network device is a positioning device and the beam information of the terminal device includes the absolute direction of the receive beam of the terminal device.

As shown in FIG. 11, a positioning server obtains that a direction of a transmit beam, relative to the terminal device, that is of the base station and reported by the base station is 135 degrees north by west. Based on the direction of the transmit beam, when there is a direct path between the base station and the terminal device, the direction of the receive beam of the terminal device should theoretically be 45 degrees north by east. In practice, both the transmit beam and the receive beam have a width. For example, if a width of the transmit beam of the base station is 30 degrees, it may be determined that there is a direct path between the terminal device and the base station when the direction of the receive beam that is reported by the terminal device is centered at 45 degrees north by east, with a 15-degree offset to either side. Similarly, if a beam of the terminal device has a width, for example, a beam width of the terminal device is 30 degrees, it may be determined that there is a direct path between the terminal device and the base station when the direction of the receive beam of the terminal device is centered at 45 degrees north by east, with a 30-degree offset to either side.

In an example, assuming that an angle of the direction of the transmit beam that is reported by the base station is θ, a beam width is Δθ, the direction of the receive beam that is reported by the terminal device is α, and a beam width is Δα, it may be determined that there is a direct path between the base station and the terminal device when a condition expressed by the following formula is met: 180−(Δθ+Δα)/2<=|α−θ|<=180+(Δθ+Δα)/2.

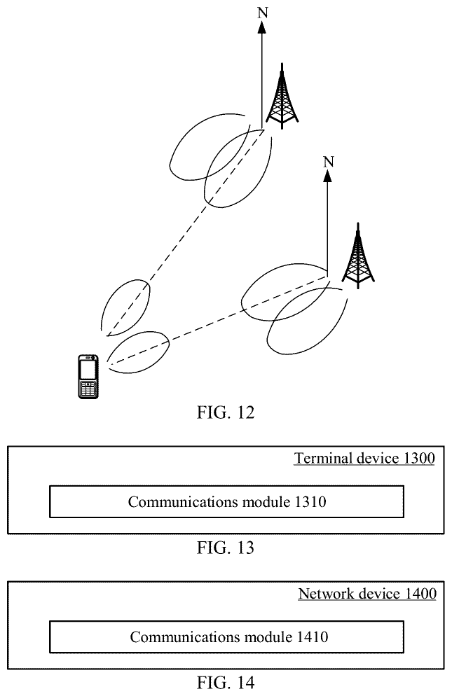

With reference to FIG. 12, another example of a process of detecting a line of sight is provided below by using an example in which the network device is a positioning device and the beam information of the terminal device includes the relative direction of the receive beam of the terminal device (that is, the direction of the receive beam is a difference between directions of received beams for two base stations).

As shown in FIG. 12, when a beam transmitted by a base station A to the terminal device is in a direction of 135 degrees north by west, and a beam transmitted by a base station B to the terminal device is in a direction of 120 degrees north by west, a difference between directions of receive beams, for the two base stations, of the terminal device should be 15 degrees. In consideration of a beam width, assuming that both the base station and the terminal device have a beam width of 10 degrees, it may be determined that there is a direct path between the base station and the terminal device when the difference between directions of the receive beams is 35 degrees. When an operating frequency is in a high frequency band, a beam is relatively narrow, and whether there is a direct path between a transmitter and a receiver may be determined by using this method.

It is assumed that a transmitting direction angle reported by the base station A is θ1, a beam width is Δθ1, a receiving direction reported by the terminal device for the base station is α1, a beam width is Δα1, a transmitting direction angle reported by the base station B is θ2, a beam width is Δθ2, a receiving direction reported by the terminal device for the base station is α2, and a beam width is Δα2. When a condition expressed by the following formula is met, it may be determined that there is a direct path between the base station and the terminal device: |θ1−θ2|<=|α1−α2|+(Δθ1+Δθ2+Δα2+Δα1)/2

Referring to FIG. 5 again, in some embodiments, the target information may indicate a location of the terminal device. In other words, the network device may determine, based on the beam information of the terminal device, a location of the terminal device (that is, location estimation is performed on the terminal device). For example, when the direction of the receive beam that is reported by the terminal device is the absolute direction, a direction of the terminal device relative to the base station is determined based on the direction of the receive beam and the location of the base station. For another example, when the direction of the receive beam that is reported by the terminal device is a difference between directions of receive beams for two base stations, and if a distance, measured by the positioning device, between the terminal device and the base station changes in a range, an estimated location range of the terminal device may be narrowed by using the direction information of the receive beam.

In some embodiments, when the terminal device needs to acquire location information, the network device may transmit estimated location information to the terminal device.

FIG. 13 is a schematic structural diagram of the terminal device according to an embodiment of the present application. The terminal device 1300 shown in FIG. 13 may include a communications module 1310. The communications module 1310 may be configured to transmit beam information of the terminal device to a network device, where the network device includes a first base station, and the beam information is transmitted by the terminal device to the first base station, and transparently transmitted by the first base station to a location management function LMF; or the network device includes an LMF, and the beam information is transmitted by the terminal device to a first base station, and transparently transmitted by the first base station to the LMF; or the network device includes a location calculation server, and the beam information is transmitted by the terminal device to the location calculation server by using a wireless network.

Optionally, in some embodiments, the terminal device includes an antenna system and a beam direction collection system that are connected to each other, and the beam direction collection system is configured to control the antenna system to perform beam sweeping to acquire the beam information.

Optionally, in some embodiments, the terminal device further includes a baseband chip used for wireless communication, and the beam direction collection system is located outside the baseband chip.

Optionally, in some embodiments, the baseband chip is configured to measure a received signal of the antenna system, and the beam direction collection system performs the beam sweeping based on a measurement result of the received signal.

Optionally, in some embodiments, the beam direction collection system includes: an antenna direction control system, receiving the measurement result from the baseband chip, and determining an antenna direction adjustment value for the antenna system based on the measurement result; and an antenna direction adjustment system, adjusting an antenna direction of the antenna system based on the antenna direction adjustment value during a process of the beam sweeping.

Optionally, in some embodiments, the beam direction collection system is configured to measure a received signal of the antenna system, and perform the beam sweeping based on a measurement result of the received signal.

Optionally, in some embodiments, the beam direction collection system includes: an antenna direction control system, measuring a received signal of the antenna system, and determining an antenna direction adjustment value for the antenna system based on a measurement result of the measurement; and an antenna direction adjustment system, adjusting an antenna direction of the antenna system based on the antenna direction adjustment value during a process of the beam sweeping.

Optionally, in some embodiments, the beam information is transmitted by the beam direction collection system; or the beam information is transmitted by the baseband chip.

Optionally, in some embodiments, the beam information includes receive beam information of the terminal device; and/or transmit beam information of the terminal device.

Optionally, in some embodiments, the receive beam information includes one or more of a signal strength, a direction, or a width of a receive beam of the terminal device; and/or the transmit beam information includes one or more of a signal strength, a direction, or a width of a transmit beam of the terminal device.

Optionally, in some embodiments, the direction of the receive beam includes an absolute direction and/or a relative direction of the receive beam, and the relative direction of the receive beam indicates a difference between directions of receive beams, for a plurality of base stations, of the terminal device.

Optionally, in some embodiments, the beam information is used to determine whether there is a line of sight between the terminal device and a base station; and/or the beam information is used to locate the terminal device.

Optionally, in some embodiments, whether there is a line of sight between the terminal device and a base station is determined based on a first condition. The first condition is associated with one or more of following information: a direction of a receive beam of the terminal device; a direction of a transmit beam of the base station; a width of a receive beam of the terminal device; or a width of a transmit beam of the base station.

Optionally, in some embodiments, the first condition is associated with one or more of following information: a difference between a direction of a receive beam of the terminal device and a direction of a transmit beam of the base station; or a sum of a width of a receive beam of the terminal device and a width of a transmit beam of the base station.

Optionally, in some embodiments, the first condition includes: 180−(Δθ+Δα)/2<=|α−θ|<=180+(Δθ+Δα)/2, where α represents a direction of a receive beam of the terminal device, θ represents a direction of a transmit beam of the base station, Δα represents a width of the receive beam of the terminal device, and Δ74 represents a width of the transmit beam of the base station.

Optionally, in some embodiments, the first condition is associated with one or more of following information: a difference between directions of receive beams of the terminal device relative to a plurality of reference base stations; a difference between directions of transmit beams of the plurality of reference base stations; or a sum of widths of receive beams of the terminal device relative to the plurality of reference base stations.

Optionally, in some embodiments, the first condition includes: |θ1−θ2|<=|α1−α2|+(Δθ1+Δθ2+Δα2+Δα1)/2, where θ1 represents a direction of a transmit beam of a first reference base station in the plurality of reference base stations, α1 represents a direction of a receive beam of the terminal device relative to the first reference base station, Δθ1 represents a width of the transmit beam of the first reference base station, θ2 represents a direction of a transmit beam of a second reference base station in the plurality of reference base stations, α2 represents a direction of a receive beam of the terminal device relative to the second reference base station, Δθ1 represents a width of the transmit beam of the second reference base station, Δα1 represents a width of the receive beam of the terminal device relative to the first reference base station, and Δα2 represents a width of the receive beam of the terminal device relative to the second reference base station.

FIG. 14 is a schematic structural diagram of a network device according to an embodiment of the present application. The network device 1400 shown in FIG. 14 includes a communications module 1410. The communications module 1410 may be configured to receive beam information of the terminal device that is transmitted by the terminal device, where the network device includes a first base station, and the beam information is transmitted by the terminal device to the first base station, and transparently transmitted by the first base station to a location management function LMF; or the network device includes an LMF, and the beam information is transmitted by the terminal device to a first base station, and transparently transmitted by the first base station to the LMF; or the network device includes a location calculation server, and the beam information is transmitted by the terminal device to the location calculation server by using a wireless network.

Optionally, in some embodiments, the beam information includes receive beam information of the terminal device; and/or transmit beam information of the terminal device.

Optionally, in some embodiments, the receive beam information includes one or more of a signal strength, a direction, or a width of a receive beam of the terminal device; and/or the transmit beam information includes one or more of a signal strength, a direction, or a width of a transmit beam of the terminal device.

Optionally, in some embodiments, the direction of the receive beam includes an absolute direction and/or a relative direction of the receive beam, and the relative direction of the receive beam indicates a difference between directions of receive beams, for a plurality of base stations, of the terminal device.

Optionally, in some embodiments, the beam information is used to determine whether there is a line of sight between the terminal device and a base station; and/or the beam information is used to locate the terminal device.

Optionally, in some embodiments, whether there is a line of sight between the terminal device and a base station is determined based on a first condition. The first condition is associated with one or more of following information: a direction of a receive beam of the terminal device; a direction of a transmit beam of the base station; a width of a receive beam of the terminal device; or a width of a transmit beam of the base station.

Optionally, in some embodiments, the first condition is associated with one or more of following information: a difference between a direction of a receive beam of the terminal device and a direction of a transmit beam of the base station; or a sum of a width of a receive beam of the terminal device and a width of a transmit beam of the base station.

Optionally, in some embodiments, the first condition includes: 180−(Δθ+Δα)/2<=|α−θ|<=180+(Δθ+Δα)/2, where α represents a direction of a receive beam of the terminal device, θ represents a direction of a transmit beam of the base station, Δα represents a width of the receive beam of the terminal device, and Δθ represents a width of the transmit beam of the base station.

Optionally, in some embodiments, the first condition is associated with one or more of following information: a difference between directions of receive beams of the terminal device relative to a plurality of reference base stations; a difference between directions of transmit beams of the plurality of reference base stations; or a sum of widths of receive beams of the terminal device relative to the plurality of reference base stations.

Optionally, in some embodiments, the first condition includes: |θ1−θ2|<=|α1−α2|+(Δθ1+Δθ2+Δα2+Δα1)/2, where θ1 represents a direction of a transmit beam of a first reference base station in the plurality of reference base stations, α1 represents a direction of a receive beam of the terminal device relative to the first reference base station, Δθ1 represents a width of the transmit beam of the first reference base station, θ2 represents a direction of a transmit beam of a second reference base station in the plurality of reference base stations, α2 represents a direction of a receive beam of the terminal device relative to the second reference base station, Δθ1 represents a width of the transmit beam of the second reference base station, Δα1 represents a width of the receive beam of the terminal device relative to the first reference base station, and Δα2 represents a width of the receive beam of the terminal device relative to the second reference base station.

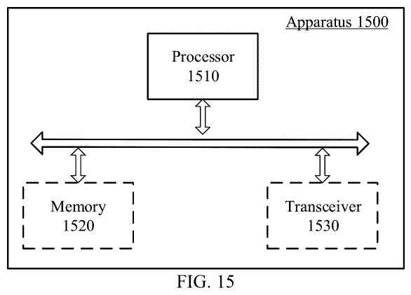

FIG. 15 is a schematic structural diagram of an apparatus according to an embodiment of the present application. The dashed lines in FIG. 15 indicate that the unit or module is optional. The apparatus 1500 may be configured to implement the methods described in the foregoing method embodiments. The apparatus 1500 may be a chip, a terminal device, or a network device.

The apparatus 1500 may include one or more processors 1510. The processor 1510 may support the apparatus 1500 to implement the methods described in the foregoing method embodiments. The processor 1510 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application-specific integrated circuit, ASIC), a field-programmable gate array (field-programmable gate array, FPGA) or another programmable logic device, a discrete gate or transistor logic device, a discrete hardware component, or the like. The general-purpose processor may be a microprocessor, or the processor may be any conventional processor or the like.

The apparatus 1500 may further include one or more memories 1520. The memory 1520 stores a program, and the program may be executed by the processor 1510 to cause the processor 1510 to execute the methods described in the foregoing method embodiments. The memory 1520 may be separate from the processor 1510 or may be integrated into the processor 1510.

The apparatus 1500 may further include a transceiver 1530. The processor 1510 may communicate with another device or chip by using the transceiver 1530. For example, the processor 1510 may transmit data to and receive data from another device or chip by using the transceiver 1530.

An embodiment of the present application further provides a computer-readable storage medium for storing a program. The computer-readable storage medium may be applied to the terminal device or the network device provided in the embodiments of the present application, and the program causes a computer to execute the methods to be executed by the terminal device or the network device in various embodiments of the present application.

An embodiment of the present application further provides a computer program product. The computer program product includes a program. The computer program product may be applied to the terminal device or the network device provided in the embodiments of the present application, and the program causes a computer to execute the methods to be executed by the terminal device or the network device in various embodiments of the present application.

An embodiment of the present application further provides a computer program. The computer program may be applied to the terminal device or the network device provided in the embodiments of the present application, and the computer program causes a computer to execute the methods to be executed by the terminal device or the network device in various embodiments of the present application.

It should be understood that, in embodiments of the present application, “B corresponding to A” means that B is associated with A, and B may be determined based on A. However, it should also be understood that, determining B based on A does not mean determining B based only on A, but instead B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

It should be understood that, the “indication” mentioned in embodiments of the present application may be a direct indication or an indirect indication, or indicate an association. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

It should be understood that, in embodiments of the present application, the term “correspond” may mean that there is a direct or indirect correspondence between the two, or may mean that there is an association relationship between the two, or may mean that there is a relationship such as indicating and being indicated, or configuring and being configured.

It should be understood that, in embodiments of the present application, the “predefined” or “preconfigured” may be implemented in a manner in which corresponding code, a table, or other related information that may be used for indication is pre-stored in a device (for example, including a terminal device and a network device). A specific implementation thereof is not limited in the present application. For example, predefined may refer to being defined in a protocol.

It should be understood that, in embodiments of the present application, the “protocol” may be a standard protocol in the communication field, which may include, for example, an LTE protocol, an NR protocol, and a related protocol applied to a future communications system. This is not limited in the present application.

It should be understood that, in embodiments of the present application, sequence numbers of the foregoing processes do not mean execution sequences. The execution sequences of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the apparatus embodiments described above are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented as indirect couplings or communication connections through some interface, apparatuses or units, and may be implemented in electrical, mechanical, or other forms.

The units described as separate parts may or may not be physically separate, and parts displayed as units may or may not be physical units, and may be located in one position, or may be distributed on a plurality of network units. Some or all of the units may be selected depending on actual requirements to achieve the objectives of the solutions in the embodiments.

In addition, function units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid-state drive (solid-state disk, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
transmitting, by a terminal device, beam information of the terminal device to a network device,
wherein the network device comprises a location management function (LMF), and the beam information is transmitted by the terminal device to the LMF via a first base station; or
the network device comprises a location calculation server, and the beam information is transmitted by the terminal device to the location calculation server by using a wireless network.

2. The method according to claim 1, wherein the terminal device comprises an antenna system and a beam direction collection circuit that are connected to each other, and the beam direction collection circuit is configured to control the antenna system to perform beam sweeping to acquire the beam information.

3. The method according to claim 2, wherein the terminal device further comprises a baseband chip used for wireless communication, and the beam direction collection circuit is located outside the baseband chip.

4. The method according to claim 3, wherein the baseband chip is configured to measure a received signal of the antenna system, and the beam direction collection circuit performs the beam sweeping based on a measurement result of the received signal.

5. The method according to claim 4, wherein the beam direction collection circuit is configured to:
receive the measurement result from the baseband chip;
determine an antenna direction adjustment value for the antenna system based on the measurement result; and
adjust an antenna direction of the antenna system based on the antenna direction adjustment value during the beam sweeping.

6. The method according to claim 3, wherein the beam direction collection circuit is configured to measure a received signal of the antenna system, and perform the beam sweeping based on a measurement result of the received signal.

7. The method according to claim 6, wherein the beam direction collection circuit is configured to:
measure a received signal of the antenna system;
determine an antenna direction adjustment value for the antenna system based on a measurement result of the measuring; and
adjust an antenna direction of the antenna system based on the antenna direction adjustment value during the beam sweeping.

8. The method according to claim 3, wherein the beam information is transmitted by the beam direction collection circuit; or the beam information is transmitted by the baseband chip.

9. The method according to claim 1, wherein the beam information comprises at least one of receive beam information of the terminal device or transmit beam information of the terminal device.

10. The method according to claim 9, wherein
the receive beam information comprises one or more of a signal strength, a direction, or a width of a receive beam of the terminal device; and
the transmit beam information comprises one or more of a signal strength, a direction, or a width of a transmit beam of the terminal device.

11. The method according to claim 10, wherein the direction of the receive beam comprises at least one of an absolute direction or a relative direction of the receive beam, and the relative direction of the receive beam indicates a difference between directions of receive beams, for a plurality of base stations, of the terminal device.

12. The method according to claim 1, wherein
the beam information is used to determine whether there is a line of sight between the terminal device and the first base station; or
the beam information is used to locate the terminal device.

13. The method according to claim 12, wherein whether there is a line of sight between the terminal device and the first base station is determined based on a first condition, and the first condition is associated with one or more of following information:
a direction of a receive beam of the terminal device;
a direction of a transmit beam of the first base station;
a width of a receive beam of the terminal device; or
a width of a transmit beam of the first base station.

14. The method according to claim 13, wherein the first condition is associated with one or more of following information:
a difference between a direction of a receive beam of the terminal device and a direction of a transmit beam of the first base station; or
a sum of a width of a receive beam of the terminal device and a width of a transmit beam of the first base station.

15. The method according to claim 14, wherein the first condition comprises: 180−(Δθ+Δα)/2<=|α−θ|<=180+(Δθ+Δα)/2, wherein α represents a direction of a receive beam of the terminal device, θ represents a direction of a transmit beam of the first base station, Δα represents a width of the receive beam of the terminal device, and Δθ represents a width of the transmit beam of the first base station.

16. The method according to claim 13, wherein the first condition is associated with one or more of following information:
a difference between directions of receive beams of the terminal device relative to a plurality of reference base stations;
a difference between directions of transmit beams of the plurality of reference base stations; or
a sum of widths of receive beams of the terminal device relative to the plurality of reference base stations.

17. The method according to claim 16, wherein the first condition comprises: |θ1−θ2|<=|α1−α2|+(Δθ1+Δθ2+Δα2+Δα1)/2, wherein θ1 represents a direction of a transmit beam of a first reference base station in the plurality of reference base stations, α1 represents a direction of a receive beam of the terminal device relative to the first reference base station, Δθ1 represents a width of the transmit beam of the first reference base station, θ2 represents a direction of a transmit beam of a second reference base station in the plurality of reference base stations, α2 represents a direction of a receive beam of the terminal device relative to the second reference base station, Δθ2 represents a width of the transmit beam of the second reference base station, Δα1 represents a width of the receive beam of the terminal device relative to the first reference base station, and Δα2 represents a width of the receive beam of the terminal device relative to the second reference base station.

18. A wireless communication method, comprising:
receiving, by a network device, beam information of a terminal device,
wherein the network device comprises a location management function (LMF), and the beam information is received by the LMF from a terminal device via a first base station; or
the network device comprises a location calculation server, and the beam information is received from the terminal device by the location calculation server by using a wireless network.

19. The method according to claim 18, wherein the beam information comprises at least one of receive beam information of the terminal device or transmit beam information of the terminal device.

20. A terminal device, comprising:
at least one processor;
one or more non-transitory computer-readable storage media coupled to the at least one processor and storing programming instructions for execution by the at least one processor, wherein the programming instructions, when executed, cause the terminal device to perform operations comprising:
transmitting beam information of the terminal device to a network device,
wherein the network device comprises a location management function (LMF), and the beam information is transmitted to the LMF via a first base station; or
the network device comprises a location calculation server, and the beam information is transmitted to the location calculation server by using a wireless network.
